(19) United States
(12) Patent Application Publication
(10) Pub. No.: US 2008/0093272 A1
(43) Pub. Date: Apr. 24, 2008

(54) Method for identifying articles and signature comparator

(75) Inventors: Franz Kreitmeier, Konstanz (DE); Ingolf Rauh, Reichenau (DE)

Correspondence Address: SIEMENS SCHWEIZ AG;I-47, INTELLECTUAL PROPERTY, ALBISRIEDERSTRASSE 245, ZURICH, CH-8047, omitted

(73) Assignee: Siemens Aktiengesellschaft, Munich (DE)

(21) Appl. No.: 11/975,983

(22) Filed: Oct. 23, 2007

(30) Foreign Application Priority Data
Oct. 24, 2006 (DE) 10 2006 050 083.0

(51) Int. Cl. B07C 5/00

(52) U.S. Cl. 209/547

(57) ABSTRACT

To identify articles, a signature for an article that is processed on a sorting plant is formed. The signature comprises characteristic features of the article. The signature is compared with a predetermined number of first signatures of articles of a search space formed in an earlier signature formation during processing on a different sorting plant. The search space is limited by sorting plant data, which is associated with the article, of the sorting plant that processes the article for identification. The sorting plant data is obtained from a sorting logic by which a sequence of at least one of sorting plants and sorting programs that are to be passed through is defined.

### CROSS-REFERENCE TO RELATED APPLICATIONS

This patent application claims the priority of German patent application 10 2006 050 083.0, filed Oct. 24, 2006, the entire contents of which is hereby incorporated herein by reference.

### BACKGROUND OF THE INVENTION

The invention relates to a method for identifying articles, wherein a signature comprising characteristic features of the article is formed for an article that is processed on a sorting plant, and wherein, for identification of the article, the signature is compared with a large number of first signatures of articles of a search space formed in an earlier signature formation during processing on a different sorting plant. The invention also relates to a signature comparator for identifying articles with an arithmetic-logic unit for forming a signature for an article comprising the characteristic features of the article, and for identifying the article by comparing the signature with a large number of first signatures of articles of a search space formed in an earlier signature formation.

Items for posting, such as letters, large letters, magazines and the like, are sorted in sorting centers in a plurality of sorting runs. The first sorting run can for example sort the articles for posting into postcode groups, a second sorting run into individual postcodes and a third sorting run into street and house number. During the first sorting run the address of the mailings is read by an OCR device (Optical Character Recognition) and associated in a data record in a memory with an identification code that is applied to the respective mailing in the form of a bar code. If the address or parts thereof should not be machine-readable, the non-machine-readable characters are read by a processor in a video encoding method and the result likewise stored in a data record.

Application of the bar code is associated with the drawback that printers and readers have to be available for that purpose and that these involve additional costs for consumables and maintenance. The black or fluorescent bar code also disrupts the mailing image, and this is undesirable in particular in the case of mailings with images that can be seen from the outside.

A method is known from WO 91/09688 A1 with which the identifying bar code can be omitted. A mailing image is photographed, from which characteristic features are extracted from which a first signature that characterizes the mailing is formed. The mailing image can be photographed again in a subsequent sorting run and the same or a very similar signature be formed. By comparing the signature with the first signatures stored in an appropriate memory, the data record associated with the mailing can be located and associated address information for the mailing be retrieved.

One problem in this connection is the large search space that includes all signatures. The signature has to be compared with all possible first signatures, and with a daily dispatch volume of 70,000,000 mailings in Germany, or corresponding dispatch volumes in other countries, this cannot be accomplished in terms of information technology in the short processing time that is available for the processing of mailings in the sorting plant.

To solve this problem EP 1 222 037 B1 proposes limiting the search space by also incorporating an identification number of the pigeon hole or the mailing container into which the mailing is sorted, in the mailing-based data records. This number is acquired during the subsequent sorting run and the signatures with first signatures are searched for in a search space which includes all first signatures of the corresponding mailing container. The drawback in this connection is that it must be ensured on an organizational level that no further mailing is fed to a mailing container following the first sorting run. This method can, moreover, practically only be carried out on large letter sorting plant since only they comprise automatic container recognition and container transportation.

For subsequent restriction of the search space in the mailing-based data records it is known from WO 2006/100357 A1 to insert an identification number of the sorting plant that performs the first sorting operation, or sorting machine or pigeon hole into which the mailing is sorted.

Sequencing machines for small letters provide a further possibility, into which machines small letters are introduced in a desired sorting sequence in three successive sorting runes and the containers are only ever transported inside the machine from pigeon hole to mailing feed. A method of this kind cannot be carried out in everyday container logistics in which operators empty the pigeon holes into containers which are then transported onwards, because half empty containers are often manually filled with mailings, or in a subsequent sorting run mailings are taken from a plurality of containers when they are emptied and are combined.

### SUMMARY OF THE INVENTION

It is therefore the object of the invention to disclose a method for identifying articles and a signature comparator with which a first signature that matches a signature can be quickly and reliably located.

The object oriented toward the method is achieved by a method of the type mentioned in the introduction, according to the invention the search space being limited by sorting plant data, associated with the article, of the sorting plant that processes the article for identification, the sorting plant data being obtained from a sorting logic by which a sequence of sorting plant and/or sorting programs that are to be passed through is defined. One or more item(s) of information which limit the search space can flow into the sorting process hereby without a container having to be recognized or mailings having to remain unchanged in a container. By limiting the sorting space, locating a first signature that matches a formed signature, and therewith allocation of a data record to a mailing, can be simplified and accelerated hereby and be rendered more reliable.

The articles are preferably items for posting, such as mailings, for example letters of all sizes, printed matter, magazines or the like. Printed products, in particular documents, forms, papers, labels and suchlike are also conceivable. However the invention is not limited to said articles. The sorting plant data can be identification data of a sorting plant, a stationary plant part or a sorting program. An instant at which the plant carries out a process is also conceivable.

The sorting plant data characterizes one or more corresponding sorting plants and can be a plant identification code. The sorting plant data can result from a known sorting strategy which can be a plant-encompassing, all-inclusive sorting strategy which, for example, can include all sorting plants of a sorting center, a geographic region or a state. A sorting strategy based on a single sorting plant and which includes a plurality of search runs, is also conceivable. The sorting strategy is preferably a sorting logic stored in a memory or created by an arithmetic-logic unit. The sorting plant data can be allocated to the article by allocation of the sorting plant data in a data record which comprises the article signature. Allocation in an arithmetic-logic unit, for example of the sorting plant data of the plant that is just processing an article, to the article or its data record is also possible.

In an advantageous embodiment of the invention the sorting plant data is inserted in a data record of an article which includes the first signature and a sorting target of the article. The data records for limiting the search space can thus be searched through for matching sorting plant data and data records without matching data can be rejected.

A sequence of a plurality of successive sorting runs on one or more sorting plant can be coordinated in such a way that the sequence for reaching an ultimate sorting target is controlled by a higher-order control unit in fixed manner. A sorting logic can either be stored locally or centrally for this purpose, and can describe at which location and with which sorting program a mailing of a sorting run is sorted in a subsequent sorting run. Sorting plant data, such as the location or an identification number of a sorting plant and/or a sorting program number, can be processed in this sorting logic. The sorting logic can therefore establish for example with which sorting result, for example a mailing postcode, which subsequent sorting plant and/or which subsequent sorting program the relevant mailing passes through. The sorting plant data for limiting the search space is therefore advantageously obtained from a sorting logic by which a sequence of sorting plants and/or sorting programs that are to be passed through is defined.

The sorting plant data expediently comprises identification data of the sorting plant at which identification takes place. The search space can thus be limited to mailings or associated data records which are provided for sorting by the plant at which respective identification takes place. The identification data can be data for machine identification or for clear establishment of the location, for example of the sorting center, of the plant.

In a further embodiment of the invention the sorting plant data comprises sorting program data of the sorting plant at which identification takes place. The search space can thus be limited to mailings or associated data records which are sorted using the same sorting program as the mailing to be identified.

The invention can also be developed such that the sorting plant data comprises location data and/or identification data of the sorting plant at which the first signature was formed. If for example only mailings of a single other sorting center or a single other sorting plant arrived in a sorting center at a specific instant, the search space can be limited to mailings that originate from this sorting center or this sorting plant.

The search space can also be limited by an instant at which a sorting run or a different process envisaged in a sorting logic has taken place. Thus for example in some sorting centers only high priority mailings, i.e. mailings with a higher postal rate, are sorted at specific times, and lower priority mailings at other times. Other mailing characteristics can also be temporally connected with specific sorting processes. Such being the case it is advantageous if the sorting plant data comprises an instant, at which the sorting plant on which the first signature was formed, has performed an action that is associated with the first signature formation. A high priority mailing for example can be recognized by the franking and an earlier sorting instant be deduced therefrom and the search space thus limited. The action that is associated with the first signature formation can be located within a sorting run in which the relevant mailing was sorted and in which the first signature thereof was formed. The instant can in particular be the instant of formation of the first signature or a corresponding data record.

It is also advantageous if the sorting plant data includes an instant at which the sorting plant on which identification takes place has performed an action that is associated with identification. Starting from the above example of a high priority mailing, it may be known that at the instant of identification only high-priority mailings are sorted. Since this information can emerge from the stored data records, for example by storing the level of franking, the search space can be limited to these mailings.

It may also conventionally be assumed that even later, adjacent mailings are not separated from each other to a great extent. It is therefore probable that a mailing, of which the signature has clearly been allocated to a first signature, will be followed by a mailing which was sorted earlier shortly before or after the preceding, clearly identified mailing. Containers rarely stand half full for long periods and if so are then filled with other mailings. In this regard it is advantageous if the sorting plant data of an article that has already been identified is obtained, for example from a clearly identified, preceding mailing. The search space can then be formed by all mailings which were sorted within a specific instant around the sorting instant of the identified mailing, for example 10 minutes earlier or later.

The search space can be further reduced if a first signature or a data record that includes the first signature, of an identified article is excluded from the search space.

The object oriented toward the signature comparator is achieved by a signature comparator of the type mentioned in the introduction in which according to the invention the arithmetic-logic unit is provided to limit the search space by sorting plant data associated with the article. As described above the search space can advantageously be limited and identification be accelerated and rendered more reliable hereby.

### BRIEF DESCRIPTION OF THE SEVERAL VIEWS OF THE DRAWINGS

The invention is described in more detail with reference to exemplary embodiments which are illustrated in the drawings, in which:

FIG. 1 shows a diagram of a plurality of sorting centers with sorting plant and mailing flows,

FIG. 2 shows a diagram of a data networking of a signature comparator,

FIG. 3 shows a flow chart of a method for forming first signatures,

FIG. 4 shows known data of a mailing for identification, and a search space,

FIG. 5 shows a mailing from which only the postcode could be recognized, and the search space, and

FIG. 6 shows a mailing from which no characters could be identified, and the search space.

### DETAILED DESCRIPTION OF THE INVENTION

FIG. 1 shows in a schematic diagram four sorting centers 2 in different towns. The sorting centers 2 are identified by numbers, numbers 4, 5, 2 and 7 in FIG. 1, and each accommodates. one or more sorting plants 4 with a transportation line 6 which transports mailings 8 in a large number of compartments 10. A sorting plant is shown in center #4 and is assigned the number 47. The sorting plant numbers 51 and 21 are located in centers #5 and #2. Center #7 accommodates two sorting plants 4 which bear the numbers 75 and 76.

First of all, mailings 8 are pre-sorted from the delivery zone of the sorting center 2 with number 4 on plant #47. This takes place with the aid of a sorting program with ID number 4711 which sorts all mailings 8 into compartments 10 according to postcodes of the destination addresses, 100 postcodes respectively being allocated to one compartment 10. In subsequent sorting runs on the same plant #47, which are carried out with the aid of a sorting program with ID number 4721, the mailings 8 are sorted according to individual postcodes. The mailings from the compartments 10 are subsequently packed in mailing containers and driven by lorries to other corresponding sorting centers 2. FIG. 1 shows by way of example the transportation from center #4 to centers #2 and #7 and from center #5 to center #7. Mailings 8 are sorted in centers #2 and #7 on plants #21, #75 and #76 with the aid of further sorting programs—in FIG. 1 programs #2137 and #7351 and #7631 by way of example, for example according to streets, house numbers and delivery rounds of the roundsman.

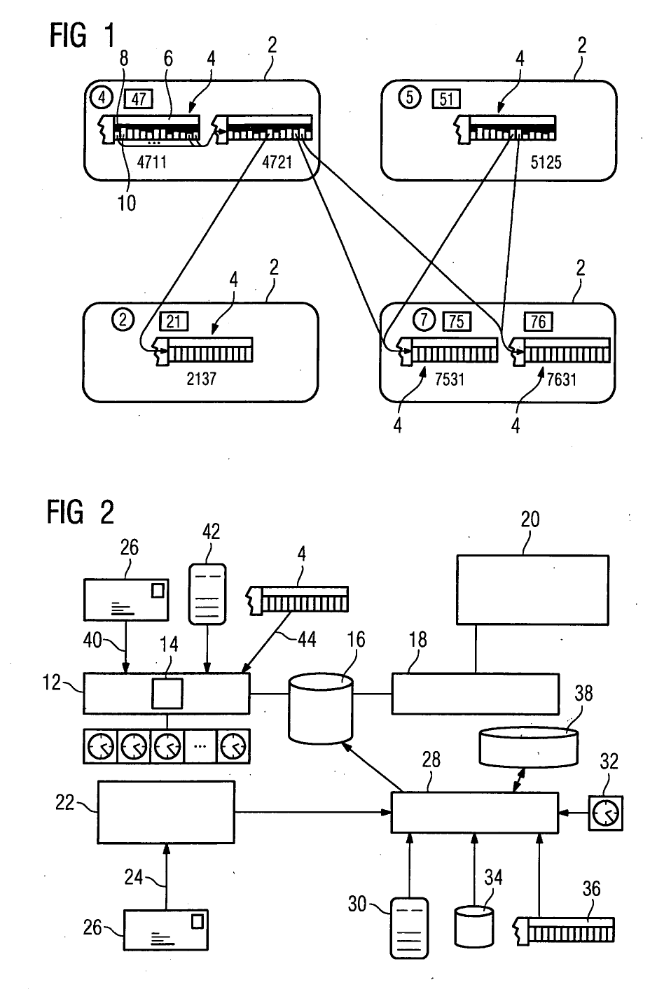

Each sorting center 2 comprises a signature comparator 12 which is shown in FIG. 2 in an embedding with further components. The signature comparator 12 comprises an arithmetic-logic unit 14 and is connected with a database 16 in which a large number of data records with signatures of mailings 8 is stored. A module 18 compares the database contents with systems 20 of other sorting centers 2 and makes use of known synchronization methods in this connection. A signature module 22 is connected to a camera 24 which photographs the mailings 8 and from each mailing image 26 creates a signature comprising characteristic features of the mailing image 26, according to a predefined algorithm. Like a fingerprint, the signature is characteristic of this one mailing 8. It is created according to known methods. A data record module 28 creates a data record for each mailing 8 and this contains the signature and the data of an OCR device 30, which reads the address of the mailing 8, in other words the address of the mailing 8 or parts thereof. The data record also contains a time which is a sorting instant of the mailing 8 and is transmitted by a system clock 32 to the data record module 28. The sorting instant can be the instant at which the data record or signature was created, or it can be a different instant at which the mailing 8 was processed for the purpose of sorting, i.e. photographed, transported, sorted or the like.

The data record module 28 also comprises an interface to a database 34, in which the sorting logic is stored, according to which the mailing 8 is sorted. The sorting logic comprises inter alia the data target sorting center, target instant and target sorting program. The data record module 28 is also connected to a memory 36 in which the nationally defined machine identification of the sorting plant 2 is stored. A configuration database 38 provides statements on which sorting machine 2 and in which timeslot a sorting program is running nationally. The configuration database 38 can be continuously updated via the signature module 22. The many logical interfaces shown in FIG. 2 can be physically formed by a single interface. It is not necessary for all logical interfaces to exist, according to the size of the search space.

The signature comparator 12 also comprises an interface 40 to a camera for photographing a mailing image 26 in a subsequent sorting run, and an interface to an OCR device 42 via which the data of the OCR device 42 can be read. In a first and second sorting run on the same sorting plant 4 the OCR devices 30, 42 can also be formed by just a single device. There is also an interface 44 for inputting the identifier of the sorting program or the sorting plant 4. The signature comparator 12 can also access a storage module 46 in which the sorting times, located signatures and identifications of the first or earlier sorting runs of the last N mailings 8 are stored.

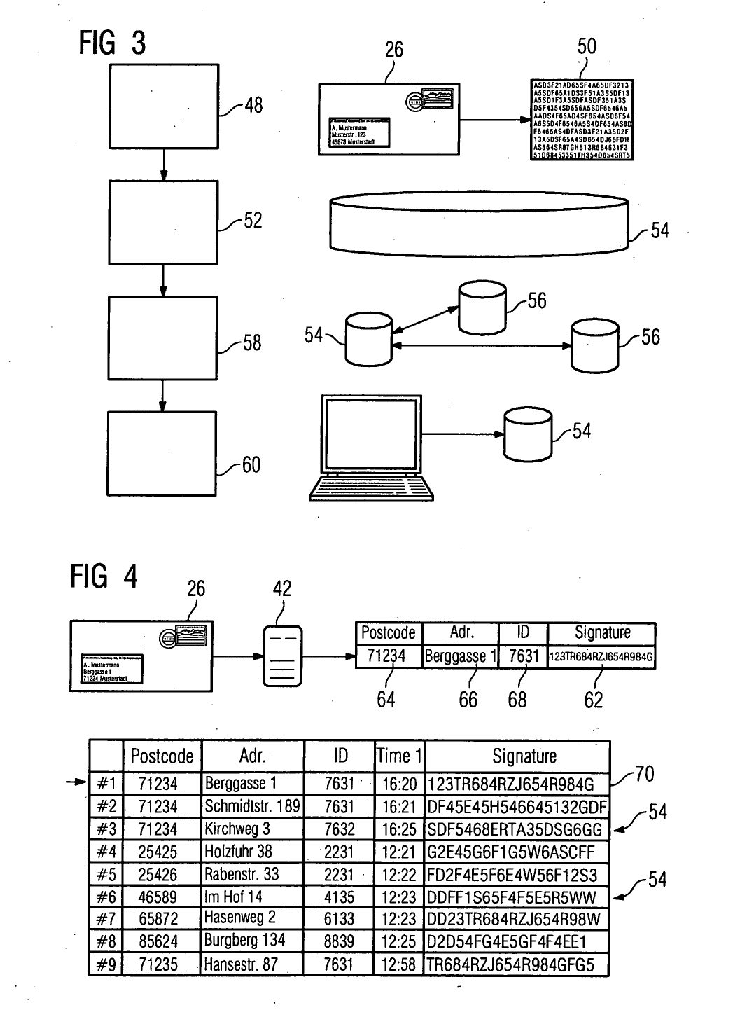

FIG. 3 shows a simplified flowchart of a signature formation, in particular a formation of a first signature 50. In the first sorting run a first signature 50 is first of all formed in a first method step 48 from a mailing image 26. The first signature 50 is then written with the data record module 28 into a data record 54 in a subsequent method step 52 and this is supplemented by data of the OCR device 30, 42, such as postcode, street and house number. Identification of the sorting plant 4 and sorting program is also written into the data record 54 along with the identification of the sorting program and sorting plant 4 with which the mailing 8 is sorted according to the sorting logic in a subsequent sorting run. The current system time is also written into the data record 54. The data record 54 is accordingly compared with other signature comparing systems 56 and optionally supplemented with data from a video encoding 60. Creation of the first signature 50 and the data record 54 is concluded hereby.

During the further course the mailing 8 is supplied to a further and more refined sorting run. Here a mailing image 26 is taken again, as is shown in FIG. 4, and a new signature 62 formed therefrom. The address of the mailing 8, primarily the postcode 64 and the delivery point 66, i.e. the street and the house number, is read by means of the OCR device 42. This data and sorting plant data 68 of the sorting plant 4 which is just processing the mailing 8, in FIG. 4 the program number 7631 of the instantaneously active sorting program, are available to the signature comparator 12.

This is prepared to locate with the aid of a comparison of the signature 62 with first signatures 50, which were taken earlier and form a search space 70, of a large number of mailings 8, the first signature 50 of the mailing 8 and therewith the data record 54 pertaining to this mailing 8. The search space 70 includes all data records 54 of all mailings 8 which have been previously sorted in a region in a period, for example in one state on one day. A relatively small state with a daily dispatch volume of about 2,000,000 mailings can be taken as an example. The search space 70 then comprises 2,000,000 data records.

FIG. 4 indicates the search space 70 by a list of 9 data records 54. The data records 54 each include the first signature 50 of the mailing 8, the postcode 64 and the delivery point 66 as well as the sorting plant data 68, the program number of the sorting program which the sorting logic has allocated to the mailing 8 in the first sorting run from its data, inter alia its address and the sorting program of the first sorting run. This program number is the number of the sorting program in which the mailing 8 has to be identified in the subsequent sorting run.

The identification of mailing 8 indicated in FIG. 4 is very simple since the OCR device 42 could read the entire address. According to the invention this is the case with 75% of the mailings 8, i.e. in this example with 1,600,000 mailings. Only one data record matches the read address and this is identified in FIG. 4 by #1. A signature comparison could in principle be superfluous here since the data record #1 can unquestionably be allocated to mailing 8.

It may be the case however that a plurality of mailings has the same delivery point 66 and are to be kept apart. This is possibly not important for sorting but can be meaningful for tracking a mailing if it should at all times be known where a certain mailing 8 is currently located.

Further data that is important to sorting can also be stored in the data record 54, such as franking, i.e. whether the mailing has high priority or low priority and should be sorted immediately or later, or weight, rigidity, size, etc. Signature comparison is also required for this purpose for clear allocation of the data record 54 to the matching mailing 8 in a pool of a plurality of mailings 8 of a delivery point 66.

Once the mailing 8 has been identified its data record 54 can therefore be allocated to it, so the data record 54 may be removed from the search space 70. If a plurality of mailings 8 exist for a delivery point 66, signature comparison is important for this too in order to be able to locate the correct data record 54 for each of these mailings 8 and remove it from the search space 70.

FIG. 5 shows an example in which the OCR device 42 could only read the postcode 64. Experience has shown that this is the case with a further 20% of mailings, i.e. 300,000 mailings, so at least the postcode 64 can be read in the case of 95% of mailings. Three data records 54 can be considered from the search space 70 indicated in FIG. 5, namely data records 54 #1 to #3. However, the sorting plant data 68, in the example sorting program number #7631, is also known to the signature comparator 12. Only the data records 54 #1 and #2 carry this sorting program number #7631, so the search space 70 can be limited to these two data records 54.

Conversely the sorting program number can also be the number of the sorting program of the first sorting run. During the subsequent sorting run it may be deduced with the aid of the sorting logic which sorting run preceded the instantaneous and known sorting run.

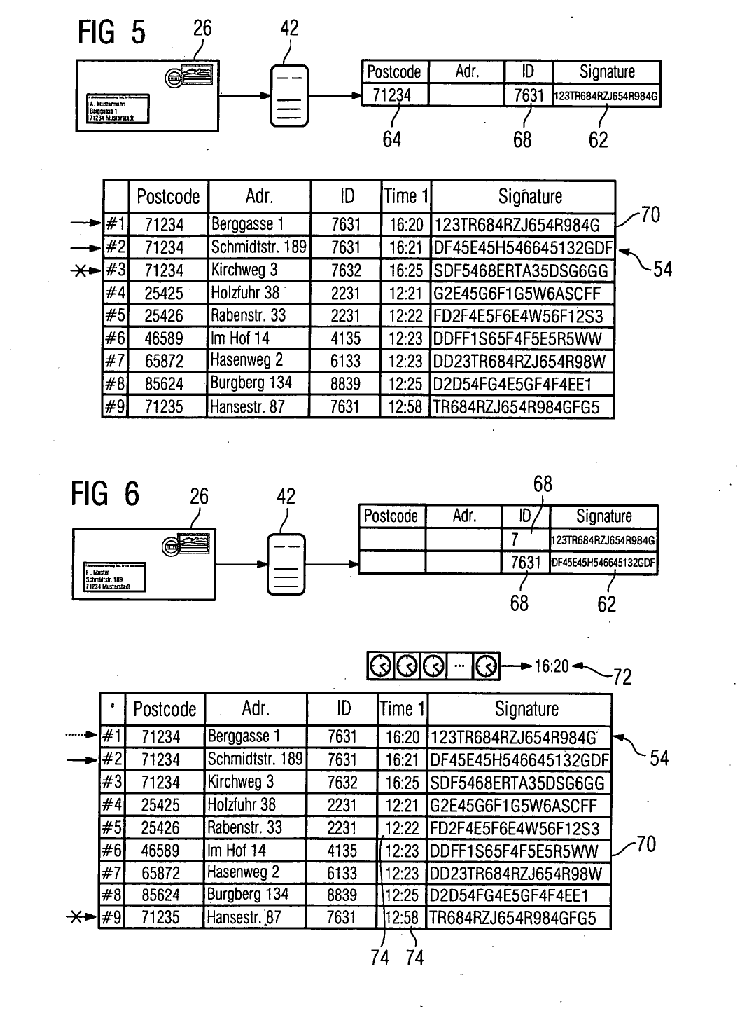

Of the 2,000,000 mailings used by way of example, 100,000 remain of which the address cannot be machine read. FIG. 6 shows this in an example. Only the sorting plant data 68 is known. If this only comprises the number of the sorting center of the subsequent sorting run, number 7 in FIG. 6, the search space 70 can already be considerably reduced. If it is assumed that the largest sorting center 2 of a state receives 50% of the dispatch volume, the search space 70 can already be halved in this disadvantageous case. If the sorting program number is known, number 7631 in FIG. 6, the search space 70 can be significantly further reduced. In FIG. 6 another three data records 54 can be considered, namely those with numbers #1, #2 and #9.

In a further example the mailing 8 pertaining to data record 54 #1 has been clearly recognized in advance. This data record 54 can be removed from the search space 70 for further mailings 8. The instant 72 at which this mailing 8 was sorted in advance, i.e. in the sorting run on which the data record 54 was created, is known to the signature comparator 12 from the data record 54. Since it can be assumed that adjacent mailings 8 with the same destination are not separated very far from each other in further sorting runs either, the signature comparator 12 limits the search space 70 to all data records 54 which bear an instant 74 in a period of 10 minutes either side of instant 72, i.e. all data records 54 with instants between 16.10 hours and 16.30 hours. The previously considered data record 54 #9 can be removed from the search space 70 hereby, so in this example only data record 54 #2 is considered. Conventionally a large number of data records 54 can still be considered, so exact determination takes place in the reduced search space 70 by signature comparison.

To limit the search space 70 it is also possible to use an instant 72 of the instantaneous search run. If a property of the mailing 8 emerges from this instant 72, for example because at this instant 72 only mailings 8 are sorted from the sorting center 2 #4 or only high priority mailings 8 are sorted, the search space 70 can be limited hereby.

The situation can occur where the OCR device 42 reads the address incorrectly, for example owing to slippage of an address in a letter window. A data record 54 that matches the mailing 8 is not found in this instance. All OCR data can accordingly be dropped and the procedure be as described with respect to FIG. 6. Should the search space 70 be too large in this connection, the mailing 8 can be rejected and be re-inserted following the sorting run. Removing the already allocated data records 54 from the search space 70 considerably reduces the search space from then on, so a signature comparison can easily be carried out even without OCR data.

We claim:

1. A method for identifying articles, comprising:
forming a signature for an article that is processed on a sorting plant, the signature comprising characteristic features of the article; and
comparing the signature with a predetermined number of first signatures of articles of a search space formed in an earlier signature formation during processing on a different sorting plant, wherein the search space is limited by sorting plant data, which is associated with the article, of the sorting plant that processes the article for identification, the sorting plant data being obtained from a sorting logic by which a sequence of at least one of sorting plants and sorting programs that are to be passed through is defined.

2. The method of claim 1, wherein the sorting plant data is inserted in a data record of an article which comprises one of the first signatures and a sorting destination of the article.

3. The method of claim 1, wherein the sorting plant data comprises identification data of the sorting plant at which identification takes place.

4. The method of claim 1, wherein the sorting plant data comprises sorting program data of the sorting plant at which identification takes place.

5. The method of claim 1, wherein the sorting plant data comprises at least one of location data and identification data of the sorting plant at which the first signatures were formed.

6. The method of claim 1, wherein the sorting plant data comprises an instant at which the sorting plant, on which the first signatures were formed, has carried out an action associated with the first signature formation.

7. The method of claim 1, wherein the sorting plant data comprises an instant at which the sorting plant, on which identification takes place, has carried out an action associated with identification.

8. The method of claim 1, wherein the sorting plant data is obtained from an article that has already been identified.

9. The method of claim 1, wherein a first signature of an identified article is excluded from the search space.

10. A signature comparator configured to couple to a database storing data records with signatures of articles, each signature comprising characteristic features of an article, comprising:
an arithmetic-logic unit configured to access the data records of said database, and to compare a signature of an article that is processed on a sorting plant with a predetermined number of first signatures of articles of a search space formed in an earlier signature formation during processing on a different sorting plant, wherein the arithmetic-logic unit is further configured to limit the search space by sorting plant data, which is associated with the article, of the sorting plant that processes the article for identification, the sorting plant data being obtained from a sorting logic by which a sequence of at least one of sorting plants and sorting programs that are to be passed through is defined.
